(19) United States
(12) Patent Application Publication
(10) Pub. No.: US 2026/0322189 A1
(43) Pub. Date: Oct. 15, 2026

(54) MAGNETIC AXIAL DEVIC

(71) Applicant: Yuliia Yuriivna BONDARENKO, Kharkiv (UA)

(72) Inventor: Yuliia Yuriivna BONDARENKO, Kharkiv (UA)

(21) Appl. No.: 19/108,221

(22) PCT Filed: May 22, 2023
(86) PCT No.: PCT/UA2023/000025

§ 371 Date: Mar. 3, 2025

(30) Foreign Application Priority Data
Jan. 25, 2023 (UA) A 2023 00261

(51) Int. Cl. H02K 1/18; H02K 16/02

(52) U.S. Cl. CPC H02K 1/182; H02K 16/02

(57) ABSTRACT

The invention relates to magnetic axial devices used as motors or generators to generate electrical energy. A magnetic axial device (1) comprises at least one stator (3) installed on a shaft (2) and having magnetic components (7) at least part of which are placed on a limited peripheral annular section of at least one of its disk-shaped end faces (5) being the prospective zone (6) of the disk-shaped end face (5) of the stator (3), at least one disk-shaped rotor (4) installed on the shaft (2) and having magnetic components (8) and made with the possibility of axial rotation and interaction with the stator (3), wherein at least part of its magnetic components (8) are placed on a limited peripheral annular section being the prospective zone (10) of the side (9) of the disk-shaped rotor (4) facing the disk-shaped end face (5) of the stator (3) having magnetic components (7). At the same time, the surfaces of interacting magnetic components (7, 8) of the stator (3) and rotor (4) have compatible volumetric shapes.

### TECHNICAL FIELD

The invention relates to electrical engineering, namely the magnetic axial devices, and can be used in the electric machines which are used as motors or generators in the sectors of industry related to the systems and devices for electrical energy generation.

### BACKGROUND ART

All magnetic axial devices with any number of stators and rotors, as well as their various types and combinations being a part of electric machines, are designed and developed taking into account various structural parameters that must ensure the functions for which they are intended. At the same time, for any design of a device for electrical energy generation, the efficiency of its operation is still an important issue.

Devices that generate magnetic electrical energy under the influence of kinetic energy or operate as a magnetic drive motor under the influence of electrical energy are known from the prior art.

The prior art knows an electrical machine with permanent magnets which has an annular stator in the grooves of which winding is placed, a rotor in the form of a ferromagnetic disk on the surface of which the magnets are placed at the stator side, wherein non-magnetic inserts are installed between those magnets and covered with a non-magnetic bandage, wherein the bandage is designed as a cup with two concentric uneven walls between which the magnets are mounted and which are interconnected by a bottom directed towards the stator (Invention patent No. UA 106842 C2, Pub. date: Oct. 10, 2014 [1]). According to the known device, the height of the smaller wall placed inside the cup of the bandage is equal to the height of the magnet, whereas the bandage wall of greater height surrounds both the disk and the magnets. At the same time, the disk is connected to the cup with a fastening element through the inner wall.

The known design of the electric machine provides a fairly reliable fixation of the magnets, however, due to structural drawbacks that lead to an uneven distribution of the flow, it has low torque, low power, and low efficiency, which results in low efficiency of its operation.

The closest prior art is a magnetic axial device, which comprises at least one stator with magnetic components mounted on a shaft and at least one disk-shaped rotor with magnetic components, made with the possibility of axial rotation and interaction with the indicated stator (European patent application EP 3 512 082 A1, Pub. date Jul. 17, 2019 [2]). The known magnetic axial device is adapted to be used as an electrical energy generator if kinetic energy is applied or as a magnetic drive motor if electrical energy is applied. It comprises a first disk-shaped rotor with several magnetic poles and a second disk-shaped rotor with several magnetic poles, wherein both rotors are placed on the shaft, a stator is installed between rotors and consists of at least two coils, each having a magnetic component in the form of a core made of magnetic material. At the same time, the magnetic poles in both disk-shaped rotors are located radially with successively changing polarity, positive and negative. At least two cores have a configuration with ends tilted towards the same side on both sides in the same direction with respect to the shaft determining a body whose development in the frontal plane is approximately diamond-shaped. In addition, the known magnetic axial device also comprises an external element that drives the first disk-shaped rotor.

The known magnetic axial device allows to create a larger magnetic field that increases the power of the electrical energy generated. However, as well as the above prior art, it has low torque, low power, and low efficiency, which results in low efficiency of its operation.

### DISCLOSURE OF INVENTION

The reason for the invention is the need for efficient magnetic axial devices with high torque, power, and efficiency.

The aim of the invention is to improve the magnetic axial device which due to the proposed embodiment of its elements and the connections between them ensures an increase in torque, power, and efficiency, resulting in the increased efficiency of its operation.

This is solved by the claimed magnetic axial device comprising at least one stator installed on a shaft and having the magnetic components and at least one disk-shaped rotor installed on a shaft and having the magnetic components and made with the possibility of axial rotation and interaction with the stator, wherein the stator has two disk-shaped end faces, while at least part of magnetic components of the stator are placed on a limited peripheral annular section of at least one of its disk-shaped end faces interacting with the specified rotor, and the limited peripheral annular section is the prospective zone of this disk-shaped end face of the stator;
at least part of magnetic components of the disk-shaped rotor are placed in a limited peripheral annular section on at least one side of the disk-shaped rotor facing the disk-shaped end face of the stator with magnetic components, and the specified limited peripheral annular section is the prospective zone of this side of the disk-shaped rotor; while
surfaces of magnetic components of the prospective zone of the disk-shaped end face of the stator and surfaces of magnetic components of the prospective zone of the disk-shaped rotor interacting with them, or surfaces of magnetic components of the prospective zone of two disk-shaped end faces of the stator and surfaces of the magnetic components of the prospective zone of the corresponding disk-shaped rotor interacting with them have compatible volumetric shapes, which increase the area of interaction of magnetic components within a limited section.

In the claimed magnetic axial device, the distance from the center of the shaft axis to the near boundary of the prospective zone of the disk-shaped end face of the stator is 0.65 . . . 0.75 of the radius in the plane of this disk-shaped end face of the stator, while the distance from the center of the shaft axis to the near boundary of the prospective zone of the side of the disk-shaped rotor, which interacts with the specified stator, is 0.65 . . . 0.75 of the radius in the plane of this side of the disk-shaped rotor.

In the claimed magnetic axial device, the surface area of the prospective zone of the disk-shaped end face of the stator which includes the sum of the surface areas of magnetic components and the stator sections of the prospective zone of the disk-shaped end face of the stator, is at least 1.25 of the area of the limited peripheral annular section in the plane of the respective disk-shaped end face of the stator and the surface area of the prospective zone of the disk-shaped rotor interacting with the specified stator and including the sum of the surface areas of magnetic components and sections of the disk-shaped rotor of the prospective zone of the disk-shaped rotor is at least 1.25 of the area of the limited peripheral annular section in the plane of this disk-shaped rotor.

According to the best embodiment of the invention, the magnetic axial device comprises a first disk-shaped rotor installed on a shaft and having the magnetic components, a second disk-shaped rotor installed on a shaft and having the magnetic components, and a stator installed between rotors and having the magnetic components. At the same time:
at least part of magnetic components of the stator are placed on the limited peripheral annular section of one disk-shaped end face of the stator and on the limited peripheral annular section of the second disk-shaped end face of the stator, which are the prospective zone of the first disk-shaped end face of the stator and the prospective zone of the second disk-shaped end face of the stator, respectively;
at least part of magnetic components of the first disk-shaped rotor are placed on the limited peripheral annular section on one side of this disk-shaped rotor facing the first disk-shaped end face of the stator, which is the prospective zone of the first disk-shaped rotor; and at least part of magnetic components of the second disk-shaped rotor are placed on the limited peripheral annular section on one side of this disk-shaped rotor facing the second disk-shaped end face of the stator, which is the prospective zone of the second disk-shaped rotor; and surfaces of magnetic components of the prospective zone of the first disk-shaped end face of the stator and surfaces of magnetic components of the prospective zone of the first disk-shaped rotor interacting with them, as well as surfaces of magnetic components of the prospective zone of the second disk-shaped end face of the stator and surfaces of the magnetic components of the prospective zone of the second disk-shaped rotor interacting with them have compatible volumetric shapes.

According to the specified embodiment, the distance from the center of the shaft axis to the near boundary of the prospective zone of the first disk-shaped end face of the stator and the distance from the center of the shaft axis to the near boundary of the prospective zone of the second disk-shaped end face of the stator is 0.65 . . . 0.75 of the radius in the plane of the respective disk-shaped end face of the stator;
the distance from the center of the shaft axis to the near boundary of the prospective zone of the first disk-shaped rotor and the distance from the center of the shaft axis to the near boundary of the prospective zone of the second disk-shaped rotor is 0.65 . . . 0.75 of the radius in the plane of the respective rotor;
the surface area of the prospective zone of the first disk-shaped end face of the stator, which includes the sum of surface areas of magnetic components and the stator sections of the prospective zone of the first disk-shaped end face of the stator, and the surface area of the prospective zone of the second disk-shaped end face of the stator, which includes the sum of surface areas of magnetic components and the stator sections of the prospective zone of the second disk-shaped end face of the stator, are at least 1.25 of the area of the limited peripheral annular section in the plane of the respective disk-shaped end face of the stator; the surface area of the prospective zone of the first disk-shaped rotor which includes the sum of the surface areas of magnetic components and sections of the first disk-shaped rotor of the prospective zone of the first disk-shaped rotor and the surface area of the prospective zone of the second disk-shaped rotor which includes the sum of the surface areas of magnetic components and sections of the second disk-shaped rotor of the prospective zone of the second disk-shaped rotor are at least 1.25 of the area of the limited peripheral annular section in the plane of the respective disk-shaped rotor.

The permanent magnets and/or electromagnets, and/or electromagnets without a core, and/or coils are used as magnetic components of the disk-shaped end face of the stator or disk-shaped end faces of the stator and as magnetic components of the disk-shaped rotor or disk-shaped rotors.

The magnetic axial device described above is an electric motor or generator.

Experimentally, the inventor discovered an onerous zone and a prospective zone to place interacting magnetic components on the disk-shaped end faces of the stator and on the disk-shaped rotor, which made it possible to exclude the onerous zone of the magnetic axial device when placing magnetic components; in addition, the inventor found the necessary shape of the surfaces of interacting magnetic components, namely its volume to increase the area of interaction of magnetic components within a limited space, which collectively influenced the design of the magnetic axial device and gave an opportunity to increase its effectiveness due to increased torque, power, and efficiency, as well as expanded embodiment combinations.

### BRIEF DESCRIPTION OF DRAWINGS

New features of the invention are specified in the claims. However, the following figures illustrate some embodiments of the invention for the purpose of its more complete explanation, not limiting the scope of the invention.

The invention is illustrated, but not limited to, by the following figures:

FIG. 1—a schematic view of a magnetic axial device with one rotor;

FIG. 2—a schematic view of a magnetic axial device with two rotors;

FIG. 3—the prospective zone of the disk-shaped end face of the stator of the magnetic axial device shown in FIG. 1;

FIG. 4—the disk-shaped end face of the stator of the magnetic axial device shown in FIG. 3 with magnetic components;

FIG. 5—the prospective zone of the disk-shaped rotor of the magnetic axial device shown in FIG. 1;

FIG. 6—the side of the disk-shaped rotor of the magnetic axial device shown in FIG. 5 with magnetic components;

FIG. 7—the prospective zone of the first disk-shaped end face of the stator of the magnetic axial device shown in FIG. 2;

FIG. 8—the first disk-shaped end face of the stator of the magnetic axial device shown in FIG. 7 with magnetic components;

FIG. 9—the prospective zone of the second disk-shaped end face of the stator of the magnetic axial device shown in FIG. 2;

FIG. 10—the second disk-shaped end face of the stator of the magnetic axial device shown in FIG. 9 with magnetic components;

FIG. 11—the prospective zone of the first disk-shaped rotor of the magnetic axial device shown in FIG. 2;

FIG. 12—the side of the first disk-shaped rotor of the magnetic axial device shown in FIG. 11 with magnetic components;

FIG. 13—the prospective zone of the second disk-shaped rotor of the magnetic axial device shown in FIG. 2;

FIG. 14—the side of the second disk-shaped rotor of the magnetic axial device shown in FIG. 11 with magnetic components;

FIG. 15—a fragment of the surface of the magnetic component with a “triangular” relief;

FIG. 16—a fragment of the surface of a magnetic component with a “gilled” relief.

To explain the essence of the invention, abbreviations are used, which within the scope of this description mean the following:
S-PZ is the prospective zone of the disk-shaped end face of the stator;
S-PZ₁ is the prospective zone of the first disk-shaped end face of the stator;
S-PZ₂ is the prospective zone of the second disk-shaped end face of the stator;
R-PZᵢₛ the prospective zone of the side of the disk-shaped rotor;
R-PZ₁ is the prospective zone of the side of the first disk-shaped rotor;
R-PZ₂ is the prospective zone of the side of the second disk-shaped rotor;
l_{S} is the distance from the center of the shaft axis to the near boundary of the prospective zone of the disk-shaped end face of the stator;
l_{S1} is the distance from the center of the shaft axis to the near boundary of the prospective zone of the first disk-shaped end face of the stator;
l_{S2} is the distance from the center of the shaft axis to the near boundary of the prospective zone of the second disk-shaped end face of the stator;
l_{R} is the distance from the center of the shaft axis to the near boundary of the prospective zone of the side of the disk-shaped rotor;
l_{R1} is the distance from the center of the shaft axis to the near boundary of the prospective zone of the side of the first disk-shaped rotor;
l_{R2} is the distance from the center of the shaft axis to the near boundary of the prospective zone of the side of the second disk-shaped rotor;
r_{S} is the radius of the disk-shaped end face of the stator;
r_{S1} is the radius of the first disk-shaped end face of the stator;
r_{S2} is the radius of the second disk-shaped end face of the stator;
r_{R} is the radius of the side of the disk-shaped rotor;
r_{R1} is the radius of the side of the first disk-shaped rotor;
r_{R2} is the radius of the side of the second disk-shaped rotor;
S_{S-PZ} is the surface area of the prospective zone of the disk-shaped end face of the stator;
S_{S-LP} is the area of the limited annular section of the disk-shaped end face of the stator in the plane;
S_{R-PZ} is the surface area of the prospective zone of the disc-shaped rotor;
S_{R-LP} is the area of the limited annular section of the disk-shaped rotor in the plane;
S_{SMC} is the surface area of the magnetic component of the stator;
S_{RMC} is the surface area of the magnetic component of the rotor;
S_{SAWM} is the surface area of a stator section without a magnetic component in the stator prospective zone;
S_{RAWM} is the surface area of a rotor section without a magnetic component in the rotor prospective zone.

### MODES FOR CARRYING THE INVENTION

The specified embodiments are described schematically and in partial views. In some cases, details that are not necessary for understanding the present invention or represent other details that are difficult to understand are not shown. Also, it should be noted that this invention is not limited to the described specific embodiments.

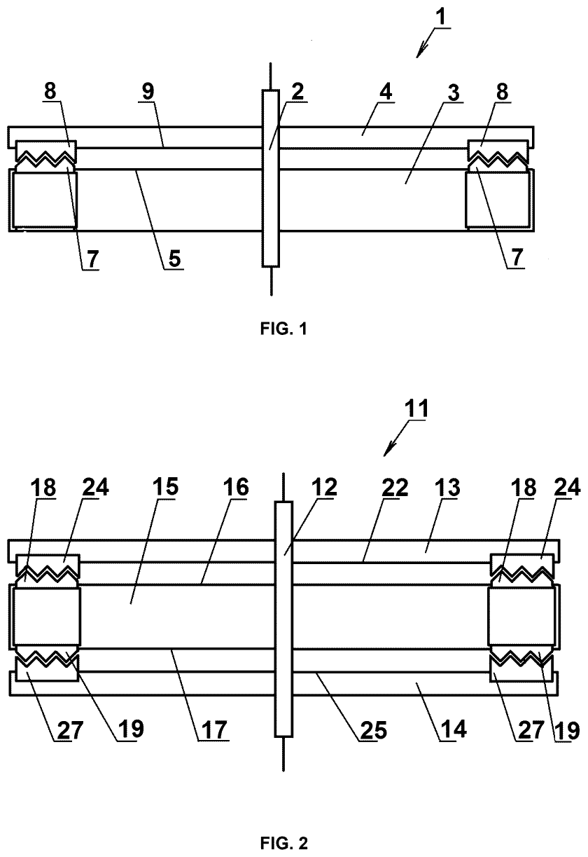

A magnetic axial device (FIG. 1, FIG. 2) comprises at least one disk-shaped stator installed on a shaft and having the magnetic components and at least one disk-shaped rotor installed on a shaft and having the magnetic components and made with the possibility of axial rotation and interaction with the specified stator.

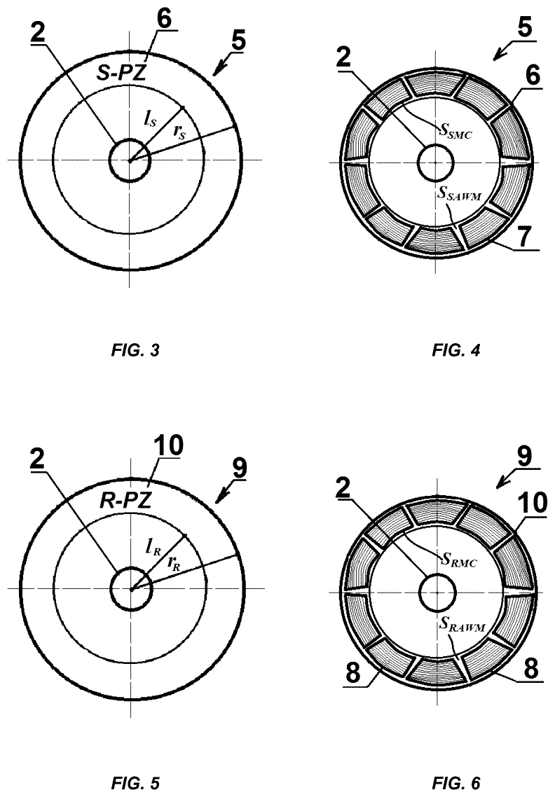

FIG. 1 schematically shows a magnetic axial device 1, which comprises a stator 3 installed on a shaft 2 and having the magnetic components and a disk-shaped rotor 4 also installed on the shaft 2 and having magnetic components and interacting with the starter. The stator 3 has two disk-shaped end faces and on one of them, the disk-shaped end face 5, on its limited peripheral annular section, which is the prospective zone 6 (S-PZ) of this disk-shaped end face 5, at least part of the magnetic components 7 of the stator 3 are placed (FIG. 3-FIG. 4). The distance l_{S} from the center of the axis of the shaft 2 to the near boundary of the prospective zone 6 in the plane of the disk-shaped end face 5 of the stator 3 is from 0.65 to 0.75 of the radius r_{S} of this disk-shaped end face. At least part of the magnetic components 8 of the disk-shaped rotor 4 are placed on its one side 9, facing the disk-shaped end face 5 of the stator 3. At the same time, magnetic components 8 are placed on the limited peripheral annular section of the side 9, which is the prospective zone 10 (R-PZ) of the side 9 of the disk-shaped rotor 4 (FIG. 1, FIG. 5-FIG. 6). The distance l_{R} from the center of the axis of the shaft 2 in the plane of the disk-shaped rotor 4 to the near boundary of the prospective zone 10 of the side 9 interacting with the stator 3 is from 0.65 to 0.75 of the radius r_{R} of this side 9 of the disk-shaped rotor 4. The surfaces of magnetic components 7 of the prospective zone 6 of the disk-shaped end face 5 of the stator 3 and the surfaces of magnetic components 8 of the prospective zone 10 of the disk-shaped rotor 4 which interact with them have compatible volumetric shapes.

The described design is one of the variants (an example of an embodiment of the invention), namely, a single-rotor magnetic axial device.

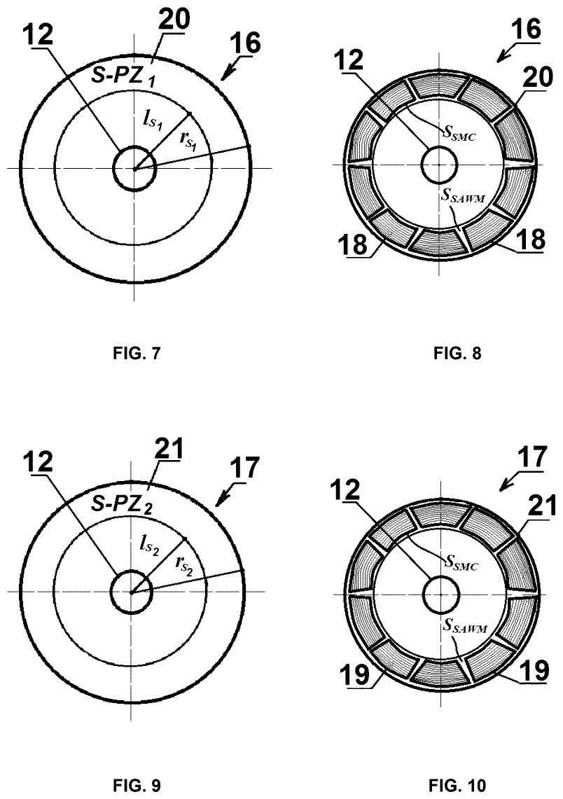

FIG. 2 schematically shows a magnetic axial device 11 comprising a first disk-shaped rotor 13 installed on a shaft 12 and having the magnetic components and a second disk-shaped rotor 14 also installed on the shaft 12 and having magnetic components, while between rotors there is a stator 15 with the magnetic components. The stator 15 has a first disk-shaped end face 16 and a second disk-shaped end face 17. At the same time, at least part of magnetic components 18 of the stator 15 are placed on the limited peripheral annular section of the first disk-shaped end face 16, which is the prospective zone 20 (S-PZ₁) of this first disk-shaped end face 16 of the stator 15; at least part of magnetic components 19 of the stator 15 are placed on the limited peripheral annular section of the second disk-shaped end face 17, which is the prospective zone 21 (S-PZ₂) of this second disk-shaped end face 17 of the stator 15 (FIG. 7-FIG. 10). The distance l_{S1} from the center of the axis of the shaft 12 to the near boundary of the prospective zone 20 in the plane of the first disk-shaped end face 16 of the stator 15 is from 0.65 to 0.75 of the radius r_{S1} of this first disk-shaped end face 16 of the stator 15 (FIG. 7). The distance l_{S2} from the center of the axis of the shaft 12 to the near boundary of the prospective zone 21 in the plane of the second disk-shaped end face 17 of the stator 15 is from 0.65 to 0.75 of the radius r_{S2} of this second disk-shaped end face 17 of the stator 15 (FIG. 9).

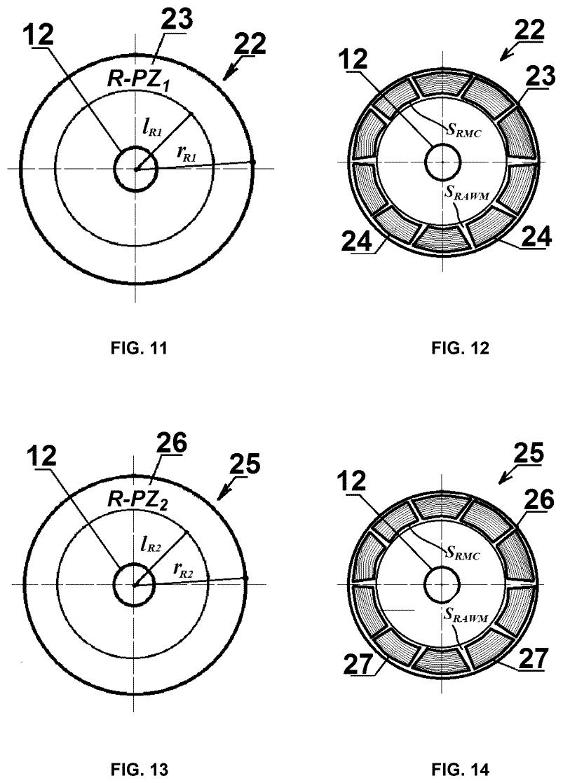

At least part of magnetic components 24 of the first disk-shaped rotor 13 are placed on the limited peripheral annular section, which is the prospective zone 23 (R-PZ₁) of its side 22 facing the first disk-shaped end face 16 of the stator 15 (FIG. 2, FIG. 11). At least part of magnetic components 27 of the second disk-shaped rotor 14 are placed on the limited peripheral annular section, which is the prospective zone 26 (l_{S}) of its side 25 facing the second disk-shaped end face 17 of the stator 15 (FIG. 2, FIG. 13). The distance lR1 from the center of the axis of the shaft 12 to the near boundary of the prospective zone 23 in the plane of the side 22 of the first disk-shaped rotor 13 interacting with the first disk-shaped end face 16 of the stator 15 is from 0.65 to 0.75 of the radius FRI of this side 22 of the first disk-shaped rotor 13 (FIG. 11); the distance lR2 from the center of the axis of the shaft 12 to the near boundary of the prospective zone 26 in the plane of the side 25 of the second disk-shaped rotor 14 interacting with the first disk-shaped end face 17 of the stator 15 is from 0.65 to 0.75 of the radius r_{R2} of this side 25 of the second disk-shaped rotor 14 (FIG. 13). The surfaces of magnetic components 18 of the prospective zone 20 of the first disk-shaped end face 16 of the stator 15 and interacting with them surfaces of magnetic components 24 of the prospective zone 23 of the first disk-shaped rotor 13 have compatible volumetric shapes. The surfaces of magnetic components 19 of the prospective zone 21 of the second disk-shaped end face 17 of the stator 15 and interacting with them surfaces of magnetic components 27 of the prospective zone 26 of the second disk-shaped rotor 14 have compatible volumetric shapes.

The described design is another embodiment of the invention, namely a two-rotor magnetic axial device.

Moreover, the described embodiments can be modules of a multi-rotor and multi-stator magnetic axial device.

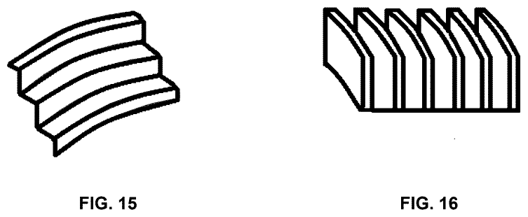

In the above-described embodiments of the claimed magnetic axial device, the three-dimensional shape of magnetic components can have a different relief, including “triangular” (FIG. 15), “gilled” one (FIG. 16), etc. The surface area of the prospective zone of the disk-shaped end face of the stator (S_{S-PZ}), which includes the sum of the surface areas of magnetic components of disk-shaped end face of the stator (ΣS_{SMC}) and the sum of the surface areas of the sections of the stator end face without magnetic components in the prospective zone of the disk-shaped end face of the stator (ΣS_{SAWM}), is not less than 1.25 of the area of the limited peripheral annular section (S_{S-LP}) in the plane of the respective disk-shaped end face of the stator, and the surface area of the prospective zone of the disk-shaped rotor (S_{R-PZ}) interacting with the specified stator and including the sum of the surface areas of magnetic components of the disk-shaped rotor (ΣS_{RMC}) and the sum of the surface areas of the disk-shaped rotor sections without magnetic components in the prospective zone of the disk-shaped rotor (ΣS_{RAWM}), is at least 1.25 of the area of the limited peripheral annular section (S_{R-LP}) in the plane of this disk-shaped rotor (FIG. 4, FIG. 6, FIG. 8, FIG. 10, FIG. 12, FIG. 14). That is:

$${S}_{S - PZ} = Σ {S}_{S M C} + Σ {S}_{S A W M} \geq 1.25 \times {S}_{S - LP} ; \qquad ( 1 )$$

$${S}_{R - PZ} = Σ {S}_{R M C} + Σ {S}_{R A W M} \geq 1.25 \times {S}_{R - LP} . \qquad ( 2 )$$

Magnetic elements having magnetic poles are used as magnetic components of the disk-shaped end face of the stator or disk-shaped end faces of the stator and as magnetic components of the disk-shaped rotor or disk-shaped rotors, namely: permanent magnets and/or electromagnets, and/or electromagnets without a core, as well as coils.

### INDUSTRIAL APPLICABILITY

When electrical power is applied, the magnetic axial device operates as a magnetic drive motor as described below.

Current pulses of the appropriate polarity are applied to the stator 3 (FIG. 1) that ensures the repulsion or attraction of magnetic components 7, placed in the prospective zone 6 of the stator 3, and magnetic components 8, placed in the prospective zone 10 of the disk-shaped rotor 4. Excitation of the magnetic field of the required polarity creates the rotational movement of the disk-shaped rotor 4.

In the case of the two-rotor magnetic axial device (FIG. 2), current pulses of the appropriate polarity are applied to the stator 15, that ensures repulsion or attraction of magnetic components 18 placed in the prospective zone 20 of the first disk-shaped end face 16 of the stator 15 and magnetic components 24 placed in the prospective zone 23 of the first disk-shaped rotor 13, as well as repulsion or attraction of magnetic components 19 placed in the prospective zone 21 of the second disk-shaped end face 17 of the stator 15 and magnetic components 27 placed in the prospective zone 26 of the second disk-shaped rotor 14. Excitation of the magnetic field of the required polarity creates the rotational movement of disk-shaped rotors 13 and 14.

In the generator operation mode, the magnetic axial device operates as follows.

Due to external traction, the rotational movement of the disk-shaped rotor 4 (FIG. 1) or the rotational movement of the first and second disk-shaped rotors 13 and 14 (FIG. 2) creates a magnetic field that excites an electric current in the stator 3 (FIG. 1) or, respectively, in the stator 15 (FIG. 2).

The claimed magnetic axial device made it possible to ensure high torque, high power, and high efficiency of the device due to the placement of magnetic components in a certain limited area and certain design of their interacting surfaces.

1. A magnetic axial device, comprising at least one stator installed on a shaft and having the magnetic components and at least one disk-shaped rotor installed on a shaft and having the magnetic components and made with the possibility of axial rotation and interaction with the specified stator, wherein
the stator has two disk-shaped end faces, while at least part of magnetic components of the stator are placed on a limited peripheral annular section of at least one of its disk-shaped end faces interacting with the specified rotor, and the specified limited peripheral annular section is the prospective zone of this disk-shaped end face of the stator, the distance from the center of the shaft axis to the near boundary of the prospective zone of the disk-shaped end face of the stator is 0.65 . . . 0.75 of the radius in the plane of this disk-shaped end face of the stator;
at least part of magnetic components of the disk-shaped rotor are placed in a limited peripheral annular section on at least one side of the disk-shaped rotor facing the disk-shaped end face of the stator with magnetic components, and the specified limited peripheral annular section is the prospective zone of this side of the disk-shaped rotor, the distance from the center of the shaft axis to the near boundary of the prospective zone of the side of the disk-shaped rotor, which interacts with the specified stator, is 0.65 . . . 0.75 of the radius in the plane of this side of the disk-shaped rotor;
surfaces of magnetic components of the prospective zone of the disk-shaped end face of the stator and surfaces of magnetic components of the prospective zone of the disk-shaped rotor interacting with them or surfaces of magnetic components of the prospective zone of two disk-shaped end faces of the stator and surfaces of the magnetic components of the prospective zone of the corresponding disk-shaped rotor interacting with them have compatible volumetric shapes, and
the surface area of the prospective zone of the disk-shaped end face of the stator which includes the sum of the surface areas of magnetic components and the stator sections of the prospective zone of the disk-shaped end face of the stator is at least 1.25 of the area of the limited peripheral annular section in the plane of the respective disk-shaped end face of the stator, and the surface area of the prospective zone of the disk-shaped rotor interacting with the specified stator and including the sum of the surface areas of magnetic components and sections of the disk-shaped rotor of the prospective zone of the disk-shaped rotor is at least 1.25 of the area of the limited peripheral annular section in the plane of this disk-shaped rotor.

2. The device according to claim 1, wherein the device comprises a first disk-shaped rotor installed on a shaft and having the magnetic components, a second disk-shaped rotor installed on a shaft and having the magnetic components, and a stator installed between rotors and having the magnetic components,
at least part of magnetic components of the stator are placed on the limited peripheral annular section of one disk-shaped end face of the stator and on the limited peripheral annular section of the second disk-shaped end face of the stator, which are the prospective zone of the first disk-shaped end face of the stator and the prospective zone of the second disk-shaped end face of the stator, respectively, the distance from the center of the shaft axis to the near boundary of the prospective zone of the first disk-shaped end face of the stator and the distance from the center of the shaft axis to the near boundary of the prospective zone of the second disk-shaped end face of the stator is 0.65 . . . 0.75 of the radius in the plane of the respective disk-shaped end face of the stator;
at least part of magnetic components of the first disk-shaped rotor are placed on the limited peripheral annular section on one side of this disk-shaped rotor facing the first disk-shaped end face of the stator, which is the prospective zone of the first disk-shaped rotor, and at least part of magnetic components of the second disk-shaped rotor are placed on the limited peripheral annular section on one side of this disk-shaped rotor facing the second disk-shaped end face of the stator, which is the prospective zone of the second disk-shaped rotor, the distance from the center of the shaft axis to the near boundary of the prospective zone of the first disk-shaped rotor and the distance from the center of the shaft axis to the near boundary of the prospective zone of the second disk-shaped rotor is 0.65 . . . 0.75 of the radius in the plane of the respective rotor; and
surfaces of magnetic components of the prospective zone of the first disk-shaped end face of the stator and surfaces of magnetic components of the prospective zone of the first disk-shaped rotor interacting with them, as well as surfaces of magnetic components of the prospective zone of the second disk-shaped end face of the stator and surfaces of the magnetic components of the prospective zone of the second disk-shaped rotor interacting with them have compatible volumetric shapes, and
the surface area of the prospective zone of the first disk-shaped end face of the stator, which includes the sum of surface areas of magnetic components and the stator sections of the prospective zone of the first disk-shaped end face of the stator, and the surface area of the prospective zone of the second disk-shaped end face of the stator, which includes the sum of surface areas of magnetic components and the stator sections of the prospective zone of the second disk-shaped end face of the stator, are at least 1.25 of the area of the limited peripheral annular section in the plane of the respective disk-shaped end face of the stator;
the surface area of the prospective zone of the first disk-shaped rotor which includes the sum of the surface areas of magnetic components and sections of the first disk-shaped rotor of the prospective zone of the first disk-shaped rotor, and the surface area of the prospective zone of the second disk-shaped rotor, which includes the sum of the surface areas of magnetic components and sections of the second disk-shaped rotor of the prospective zone of the second disk-shaped rotor, are at least 1.25 of the area of the limited peripheral annular section in the plane of the respective disk-shaped rotor.

3. The device according to claim 1, wherein the permanent magnets and/or electromagnets, and/or electromagnets without a core, and/or coils are used as magnetic components of the disk-shaped end face of the stator or disk-shaped end faces of the stator and as magnetic components of the disk-shaped rotor or disk-shaped rotors.

4. The device according to any of claim 1, wherein the device is an electric motor or generator.
